(19) United States
(12) Patent Application Publication
(10) Pub. No.: US 2009/0106098 A1
(43) Pub. Date: Apr. 23, 2009

(54) AFFILIATED ADVERTISING WIDGET

(76) Inventor: Jalem M. Getz, Waukesha, WI (US)

Correspondence Address: FOLEY & LARDNER LLP, 150 EAST GILMAN STREET, P.O. BOX 1497, MADISON, WI, 53701-1497, US

(21) Appl. No.: 11/877,025

(22) Filed: Oct. 23, 2007

(51) Int. Cl. G06Q 30/00

(52) U.S. Cl. 705/14

(57) ABSTRACT

A method of advertising includes providing a widget to an affiliate. The widget includes a link to a first network accessible location of an advertiser, and is configured to be placed on a second network accessible location of the affiliate. An affiliate identifier is associated with the widget. An identification that the link has been activated through the second network accessible location of the affiliate is made based on the affiliate identifier. An identification that a copy of the link has been activated through a third network accessible location of a third party is also made based on the affiliate identifier. An incentive is provided to the affiliate based at least in part on the activation of the copy of the link through the third network accessible location of the third party.

### FIELD

The subject of the disclosure relates generally to marketing through widgets. More specifically, the disclosure relates to an affiliated marketing system in which an advertising widget retains an affiliate identifier such that an incentive is provided to an affiliate associated with the affiliate identifier.

### BACKGROUND

A widget can refer to any computer code, software, application, etc. configured to convey information or perform a function on a computer. Widgets can convey information regarding sports, weather, products, services, news, date, time, the stock market, music, entertainment, etc. Widgets can also be games, system utilities, application enhancers, chat applications, webcams, etc. Widgets are often placed in network browser windows, in application windows, on desktops, and/or on toolbars in a computer screen.

Advertising widgets convey information regarding a product/service of an advertiser, and often include a link to the advertiser's website. The advertiser generally provides an incentive to individuals and businesses who are willing to place an advertising widget on their website. The incentive can be payment of a predetermined value, or may be based on a number of times that the link in the advertising widget is clicked by a user. Unfortunately, advertising widgets are limited in their ability to be readily transferred from a first location to a second location. Further, there is insufficient incentive for users to place advertising widgets on their websites.

Thus, there is a need for widgets which can be transferred from a first location to a second location such that an enhanced incentive to display the widget is provided to individuals and businesses.

### SUMMARY

An exemplary method of advertising includes providing a widget to an affiliate. The widget includes a link to a first network accessible location of an advertiser, and is configured to be placed on a second network accessible location of the affiliate. An affiliate identifier is associated with the widget. An identification that the link has been activated through the second network accessible location of the affiliate is made based on the affiliate identifier. An identification that a copy of the link has been activated through a third network accessible location of a third party is also made based on the affiliate identifier. An incentive is provided to the affiliate based at least in part on the activation of the copy of the link through the third network accessible location of the third party.

An exemplary system for advertising includes an affiliate computer, a third party computer, and an advertiser computer. The affiliate computer is configured to receive a widget from an advertiser. The widget includes a link to a first network accessible location of the advertiser, and an affiliate identifier. The affiliate computer is further configured to place the received widget on a second network accessible location of an affiliate. The third party computer is configured to receive a copy of the widget from the second network accessible location of the affiliate. The copy of the widget includes a copy of the affiliate identifier and a copy of the link to the first network accessible location. The third party computer is further configured to place the received copy of the widget on a third network accessible location of a third party. The advertiser computer is configured to identify, based on the affiliate identifier, that the copy of the link has been activated through the third network accessible location of the third party. The advertiser computer is further configured to provide an incentive to the affiliate based at least in part on the activation of the copy of the link.

An exemplary widget includes information regarding a product or a service of an advertiser. The widget also includes a link to a first network accessible location of the advertiser, and an affiliate identifier associated with an affiliate of the advertiser. The widget further includes a copy/paste module which allows a third party to generate a copy of the widget from a second network accessible location of the affiliate. The copy/paste module also allows the third party to paste the copy of the widget on a third network accessible location of the third party. The copy of the widget includes the affiliate identifier.

Other principal features and advantages will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings.

FIG. 1 is a flow diagram illustrating operations performed by an advertiser in accordance with an exemplary embodiment.

FIG. 2 is a block diagram illustrating an advertising hierarchy in accordance with an exemplary embodiment.

FIG. 3 is a flow diagram illustrating operations performed by an affiliate of the advertiser in accordance with an exemplary embodiment.

FIG. 4 is a block diagram illustrating a widget advertising system in accordance with an exemplary embodiment.

### DETAILED DESCRIPTION

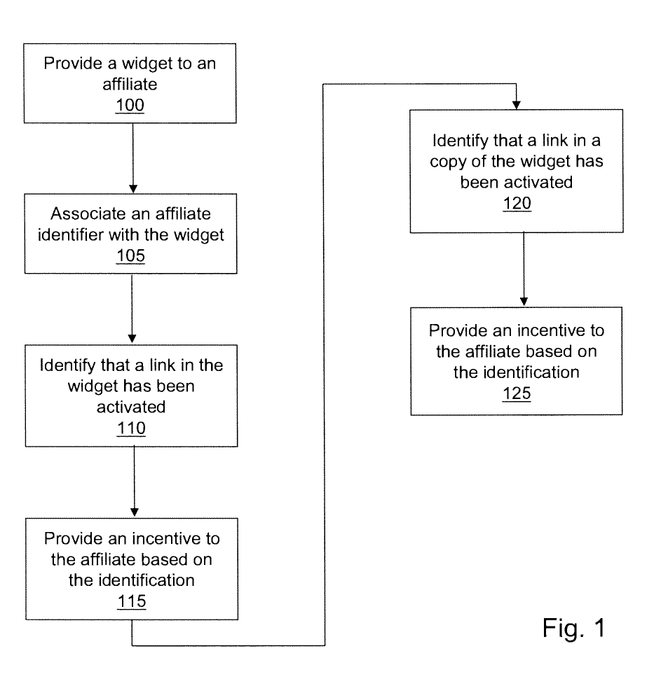

Described herein is an affiliated marketing system in which widgets are used to provide an incentive to an affiliate. FIG. 1 is a flow diagram illustrating operations performed by an advertiser in accordance with an exemplary embodiment. In alternative embodiments, fewer, additional, or different operations may be performed. In an operation 100, a widget is provided to an affiliate. A widget can refer to a portable block of computer code which can be installed and executed on any web page or other network accessible location without requiring additional compilation. In an exemplary embodiment, the widget is provided to the affiliate in response to a request for the widget from the affiliate. The widget can be electronically provided by any method known to those of skill in the art.

In an exemplary embodiment, the widget can include an advertisement for a product or a service of the advertiser. The advertisement can be a video advertisement, an audio advertisement, a textual advertisement, a graphical advertisement, or any other type of advertisement. The widget can also include a link to a network accessible location of the advertiser. For example, the widget can include a link to a website sponsored by the advertiser. Alternatively, the widget can include a link to any other network accessible location.

In an operation 105, an affiliate identifier is associated with the widget. The affiliate identifier can be any combination of numbers, letters, and/or symbols which can be used to identify a given affiliate. Alternatively, the affiliate identifier can be any other type of electronic identification. In an exemplary embodiment, the affiliate identifier can be provided to the affiliate by the advertiser. The affiliate can enter the affiliate identifier into an electronic form when the affiliate requests the widget, and the provided widget can be associated with the affiliate identifier. In another exemplary embodiment, the affiliate identifier can be appended to the link of the widget by any method known to those of skill in the art. Alternatively, the affiliate identifier can be associated with the widget by any other method.

Upon receipt of the widget, the affiliate can post the widget in a network accessible location of the affiliate. The network accessible location of the affiliate can be a website, a blog page, a personal profile location, or any other location. Once the widget is posted, visitors to the affiliate's network accessible location can experience the advertisement and click on the link embedded in the widget to obtain more information and/or purchase a product/service of the advertiser. In an operation 110, the advertiser identifies that the link in the widget has been activated from the network accessible location of the affiliate. The identification can be made when the visitor activates the link in the widget and is directed to the network accessible location of the advertiser.

In an operation 115, the advertiser provides an incentive to the affiliate based on the identification of the link activation. In an exemplary embodiment, the incentive can be monetary compensation, a discount, a product, a service, or any other reward. The advertiser can accurately attribute the activation of the link to the affiliate because of the affiliate identifier associated with the widget. In one embodiment, the affiliate identifier can be appended to the link such that the affiliate identifier is conveyed to the advertiser when the link is activated. As such, the affiliate can be provided the incentive each time a visitor activates the link from the affiliate's network accessible location. In an alternative embodiment, the affiliate may be provided the incentive only if the activation of the link by the visitor results in a sale for the advertiser. In such an embodiment, the affiliate can be paid through a sales based commission.

In an exemplary embodiment, the widget can also include a copy/paste module. The copy/paste module can allow a third party to copy the widget from the network accessible location of the affiliate and paste the copy of the widget at a network accessible location of the third party. In another exemplary embodiment, the copy of the widget can retain the affiliate identifier such that the copy of the widget is also associated with the affiliate. As such, when a visitor to the network accessible location of the third party activates the link in the copy of the widget, the link activation is still associated with the affiliate. In one embodiment, the affiliate identifier may be encrypted such that the third party is unable to alter or remove the affiliate identifier in the copy of the widget. The widget can also include instructions configured to inform the third party how to generate and paste the copy of the widget. In an operation 120, the advertiser identifies that the link in the copy of the widget has been activated. In an operation 125, the advertiser provides an incentive to the affiliate based on the identification. The incentive may be provided based on the link activation or a sale resulting from the link activation, depending on the embodiment.

Thus, the advertising widget described herein allows an affiliate of the advertiser to profit based on activations of the link by visitors to the network accessible location of the affiliate. The widget also includes a copy/paste module such that a visitor to the network accessible location of the affiliate can copy the widget and place the copy of the widget on a network accessible location of the third party. An affiliate identifier is retained in the copy of the widget such that the affiliate is rewarded when visitors to the network accessible location of the third party activate the link in the copy of the widget. In an exemplary embodiment, the copy/paste module is also retained in the copy of the widget such that a fourth party can copy the copy of the widget from the network accessible location of the third party and place it at a network accessible location of the fourth party. The affiliate identifier can also be retained in this third generation widget such that the affiliate is rewarded when visitors to the network accessible location of the fourth party activate the link in the third generation widget. The process can continue such that the affiliate is compensated for the activation of links in fourth generation widgets, fifth generation widgets, sixth generation widgets, and so on.

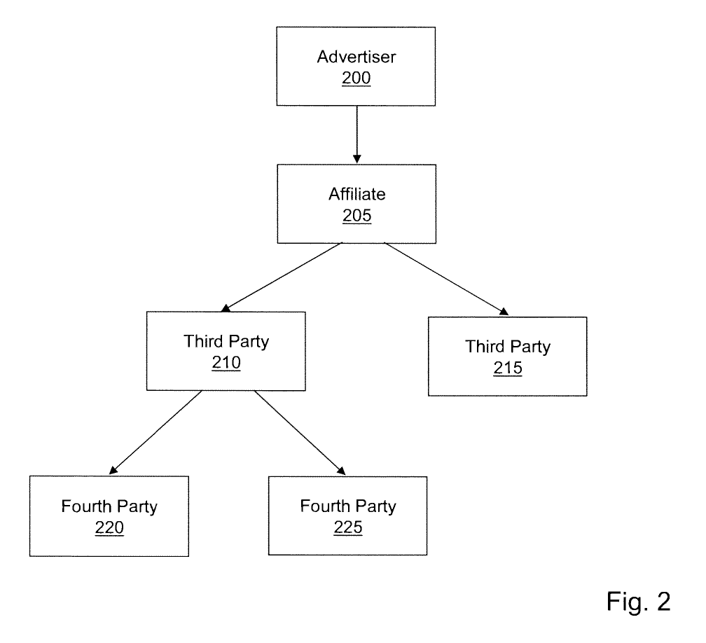

FIG. 2 is a block diagram illustrating an advertising hierarchy in accordance with an exemplary embodiment. An advertiser 200 provides a first generation widget to an affiliate 205. Affiliate 205 posts the first generation widget to a first network accessible location, and is provided an incentive when visitors to the first network accessible location activate the link in the first generation widget and/or make a purchase from advertiser 200. A third party 210 can visit the first network accessible location and make a copy of the first generation widget to create a second generation widget. The second generation widget is posted at a second network accessible location of third party 210, and the affiliate is provided an incentive when visitors to the second network accessible location activate the link in the second generation widget and/or make a purchase from advertiser 200. A third party 215 can also visit the first network accessible location of affiliate 205 and make a copy of the first generation widget to create a second generation widget. The second generation widget of third party 215 can similarly result in an incentive being provided to affiliate 205. A fourth party 220 can visit the second network accessible location of third party 210 and make a copy of the second generation widget to create a third generation widget. The third generation widget is posted at a third network accessible location of fourth party 220, and the affiliate is provided an incentive when visitors to the third network accessible location activate the link in the third generation widget and/or make a purchase from advertiser 200. A fourth party 225 can also visit the second network accessible location of third party 210 and make a copy of the second generation widget to create a third generation widget. The third generation widget of fourth party 225 can similarly result in an incentive being provided to affiliate 205. The process can continue such that affiliate 205 is able to receive incentives through hundreds or even thousands of copied widgets.

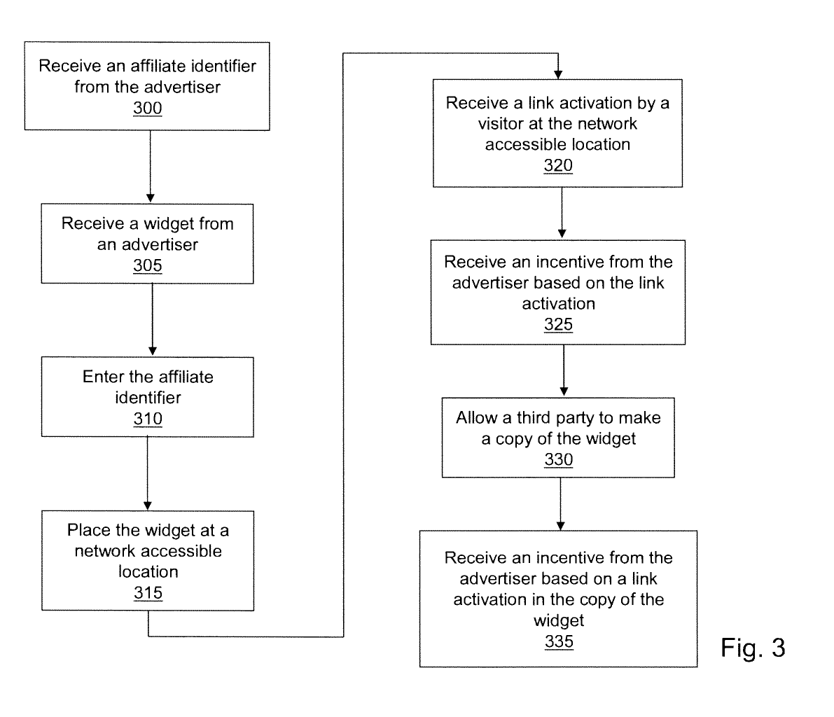

FIG. 3 is a flow diagram illustrating operations performed by an affiliate of the advertiser in accordance with an exemplary embodiment. Additional, fewer, or different operations may be performed in alternative embodiments. In an operation 300, the affiliate receives an affiliate identifier from the advertiser. In an operation 305, the affiliate receives a widget from the advertiser. In an exemplary embodiment, the widget can be provided in response to a request from the affiliate. The widget may include information regarding a product or a service of the advertiser, a link to a network accessible location of the advertiser, and a copy/paste module. In an operation 310, the affiliate enters the affiliate identifier. In an exemplary embodiment, the affiliate identifier can be entered into an electronic widget request form. Alternatively, the affiliate can provide the affiliate identifier orally through a telephone, directly into the widget, or by any other method. As such, the affiliate identifier can be associated with the widget. Alternatively, the advertiser may automatically associate the affiliate identifier with the widget when the widget is provided to the affiliate.

In an operation 315, the widget is placed at a network accessible location which is sponsored by or otherwise associated with the affiliate. In an operation 320, a link activation by a visitor is received at the network accessible location of the affiliate. In an operation 325, the affiliate receives an incentive from the advertiser based on the link activation by the visitor. In an exemplary embodiment, the incentive may be a commission which is provided to the affiliate only if the visitor makes a purchase from the advertiser. In an operation 330, the affiliate allows a third party to make a copy of the widget. The third party can place the copy of the widget on a network accessible location of the third party such that visitors can activate the link. In an operation 335, the affiliate receives an incentive from the advertiser based on a link activation in the copy of the widget by a visitor to the network accessible location of the third party.

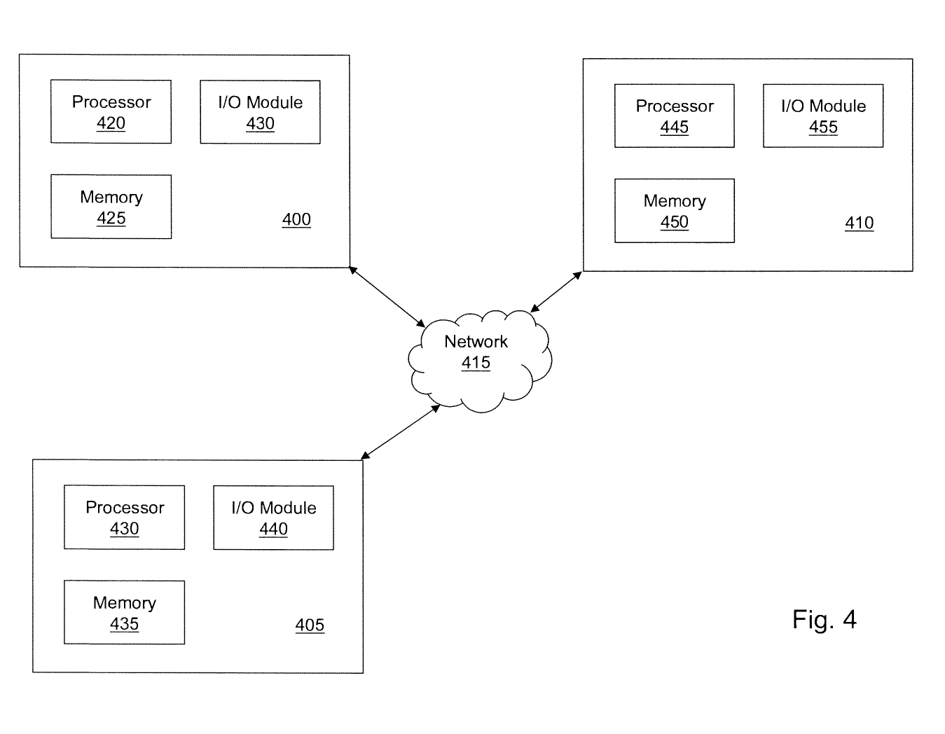

FIG. 4 is a block diagram illustrating a widget advertising system in accordance with an exemplary embodiment. The widget advertising system includes an advertiser computer 400, an affiliate computer 405, a third party computer 410, and a network 415. Network 415 can be a local area network, a wide area network such as the Internet, a wireless network, or any other type of communication medium known to those of skill in the art. Advertiser computer 400 includes a processor 420, a memory 425, and an I/O (input/output) module 430. Processor 420 is configured to determine when an activated link is associated with an affiliate identifier, memory 425 is configured to store a list of affiliate identifiers, and I/O module 430 is configured to communicate with affiliate computer 405 and third party computer 410 through network 415.

Affiliate computer 405 also includes a processor 430, a memory 435, and an I/O module 440. Processor 430 is configured to post a widget received from advertiser computer 400, memory 435 is configured to store computer code corresponding to the widget, and I/O module 440 is configured to communicate with advertiser computer 400 and third party computer 410 through network 415. Third party computer 410 similarly includes a processor 445, a memory 450, and an I/O module 455. Processor 445 is configured to copy the widget from a network accessible location of the affiliate and post the copy of the widget at a network accessible location of a third party. Memory 450 is configured to store computer code corresponding to the copy of the widget, and I/O module 455 is configured to communicate with advertiser computer 400 and affiliate computer 405 through network 415.

By way of example, an affiliate can use affiliate computer 405 to place a request for a widget from advertiser computer 400. The request can be executed by processor 430 of affiliate computer 405, sent by I/O module 440 of affiliate computer 405 through network 415, and received by I/O module 430 of advertiser computer 400. Processor 420 of advertiser computer 400 can process the request and access the requested widget from memory 425. Processor 420 of advertiser computer 400 can also associate an affiliate identifier corresponding to the affiliate with the requested widget. The affiliate identifier can be obtained from memory 425 of advertiser computer 400, or received from affiliate computer 405, depending on the embodiment. Processor 420 can also use I/O module 430 to send the requested widget to affiliate computer 405 through network 415.

Affiliate computer 405 can receive the requested widget with I/O module 440, and store the requested widget in memory 435. Processor 430 of affiliate computer 405 can be used to post the requested widget to a network accessible location of the affiliate. A visitor to the network accessible location of the affiliate can activate a link in the posted widget such that the visitor is directed to a network accessible location of the advertiser. Advertiser computer 400 can use I/O module 430 and processor 420 to identify the activation of the link. Advertiser computer 400 can also use processor 420 and memory 425 to attribute the link activation to the affiliate based on the affiliate identifier. Processor 420 can also be used to determine whether an incentive is to be provided to the affiliate. In one embodiment, the incentive may be provided in response to the activation of the link at the network accessible location of the affiliate. Alternatively, the incentive may be provided only if the visitor purchases a product or service from the advertiser.

A third party can use I/O module 455 of third party computer 410 to access the network accessible location of the affiliate. Processor 445 of third party computer 410 can be used to make a copy of the widget from the network accessible location of the affiliate, and memory 450 can be used to store the copy of the widget. Processor 445 can also be used to post the copy of the widget at a network accessible location of the third party. A visitor to the network accessible location of the third party can activate the link in the posted copy of the widget such that the visitor is directed to the network accessible location of the advertiser. Advertiser computer 400 can use I/O module 430 and processor 420 to identify the activation of the link. Advertiser computer 400 can also use processor 420 and memory 425 to attribute the link activation to the affiliate based on the affiliate identifier in the copy of the widget. Processor 420 can also be used to determine whether an incentive is to be provided to the affiliate. The incentive provided in response to the link activation through the network accessible location of the third party can be the same as the incentive provided in response to activation of the link through the network accessible location of the affiliate, or different, depending on the embodiment.

One or more flow diagrams have been used to describe exemplary embodiments. The use of flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method of advertising comprising:
providing a widget to an affiliate, wherein the widget comprises a link to a first network accessible location of an advertiser, and further wherein the widget is configured to be placed on a second network accessible location of the affiliate;
associating an affiliate identifier with the widget;
identifying, based on the affiliate identifier, that the link has been activated through the second network accessible location of the affiliate;
identifying, based on the affiliate identifier, that a copy of the link has been activated through a third network accessible location of a third party; and
providing an incentive to the affiliate, wherein the incentive is based at least in part on the activation of the copy of the link through the third network accessible location of the third party.

2. The method of claim 1, wherein the widget further comprises information regarding a product or a service of the advertiser.

3. The method of claim 1, wherein the widget further comprises a copy/paste module such that the widget is configured to be copied from the second network accessible location of the affiliate and pasted to the third network accessible location of the third party.

4. The method of claim 1, wherein the incentive is further based at least in part on the activation of the link through the second network accessible location of the affiliate.

5. The method of claim 1, wherein the incentive comprises a commission which is provided to the affiliate only if the activation of the copy of the link results in a sale for the advertiser.

6. The method of claim 1, wherein the incentive comprises a commission which is provided to the affiliate only if the link activation through the second network accessible location of the affiliate results in a sale for the advertiser.

7. The method of claim 1, further comprising appending the affiliate identifier to the link.

8. The method of claim 1, further comprising encrypting the affiliate identifier such that the affiliate identifier is protected in a copy of the widget.

9. A system for advertising comprising:
a third party computer configured to
receive a copy of a widget from a second network accessible location of an affiliate, wherein the copy of the widget includes a copy of an affiliate identifier and a copy of a link to a first network accessible location of an advertiser; and
place the received copy of the widget on a third network accessible location of a third party; and
an advertiser computer configured to
identify, based on the affiliate identifier, that the copy of the link has been activated through the third network accessible location of the third party; and
provide an incentive to the affiliate based at least in part on the activation of the copy of the link.

10. The system of claim 9, further comprising an affiliate computer configured to:
receive the widget from the advertiser, wherein the widget comprises the link to the first network accessible location of the advertiser, and further wherein the widget includes the affiliate identifier; and
place the received widget at the second network accessible location of the affiliate.

11. The system of claim 10, wherein the advertiser computer is further configured to:
identify, based on the affiliate identifier, that the link has been activated through the second network accessible location of the affiliate; and
provide an incentive to the affiliate based at least in part on the activation of the link through the second network accessible location.

12. The system of claim 11, wherein the incentive is provided only if the activation of the link through the second network accessible location results in a sale by the advertiser.

13. The system of claim 9, wherein the widget further comprises information regarding a product or a service of the advertiser.

14. The system of claim 9, wherein the affiliate identifier is encrypted to protect the affiliate identifier from alteration and removal from the copy of the widget.

15. The system of claim 9, wherein the incentive comprises a commission based on a sale by the advertiser which results from the activation of the copy of the link through the third network accessible location.

16. The system of claim 9, wherein the third network accessible location of the third party comprises at least one of a web page, a blog page, and a personal profile page.

17. A widget comprising:
information regarding a product or a service of an advertiser;
a link to a first network accessible location of the advertiser;
an affiliate identifier associated with an affiliate of the advertiser; and
a copy/paste module which allows a third party to generate a copy of the widget from a second network accessible location of the affiliate and paste the copy of the widget on a third network accessible location of the third party, wherein the copy of the widget includes the affiliate identifier.

18. The widget of claim 17, wherein the affiliate identifier is associated with the widget when the affiliate provides the affiliate identifier as part of a request for the widget.

19. The widget of claim 17, further comprising instructions configured to inform the third party how to generate and paste the copy of the widget.

20. The widget of claim 17, wherein the affiliate identifier is encrypted such that the affiliate identifier is protected from alteration.
